(19) United States
(12) Patent Application Publication
(10) Pub. No.: US 2024/0352245 A1
(43) Pub. Date: Oct. 24, 2024

(54) RESIN COMPOSITION FOR THREE-DIMENSIONAL PHOTOSHAPING

(71) Applicant: NAGASE CHEMTEX CORPORATION, Osaka-shi, Osaka (JP)

(72) Inventors: Koji WATANABE, Hyogo (JP); Hiroaki OZOE, Hyogo (JP)

(21) Appl. No.: 18/685,589

(22) PCT Filed: Aug. 17, 2022
(86) PCT No.: PCT/JP2022/031000

§ 371 Date: Feb. 22, 2024

(30) Foreign Application Priority Data
Aug. 25, 2021 (JP) 2021-137166

(51) Int. Cl. C08L 33/08; B22C 9/10; B29C 64/124; B29L 31/00; B33Y 10/00; B33Y 70/00; B33Y 80/00; C08K 5/13; C08K 5/37; C08K 5/5397

(52) U.S. Cl. CPC C08L 33/08; B22C 9/10; B29C 64/124; B33Y 10/00; B33Y 70/00; B33Y 80/00; C08K 5/13; C08K 5/37; C08K 5/5397; B29K 2833/08; B29L 2031/757

(57) ABSTRACT

Provided is a resin composition for three-dimensional photofabrication which, after curing, melts at a relatively low temperature of about 200° C. and which is excellent in fabricability. The present invention relates to a resin composition for three-dimensional photofabrication, containing a reactive material having in a molecule thereof an acetal structure and a crosslinkable double bond.

### TECHNICAL FIELD

The present invention relates to a resin composition for three-dimensional photofabrication, a three-dimensionally fabricated object obtained by photocuring the composition, and a method for producing a cast product with the composition.

### BACKGROUND ART

Metallic cast products used in dentistry, jewelry, and other applications have been conventionally produced by investing three-dimensionally fabricated objects produced with wax in investment materials, and then solidifying the investment materials, followed by firing at high temperatures of 700° C. to 800° C. to remove the wax and thereby produce casting molds for forged products, and then pouring metals into the casting molds. Here, the three-dimensionally fabricated objects produced with wax are produced by pouring wax into molds of desired shapes and solidifying the wax, and therefore the molds need to be separately produced. The production of such molds requires craftsmanship to process them, and is not suitable for the production of small-lot forged products.

Producing three-dimensionally fabricated objects with photocurable materials by 3D printers requires no need for molds for production of three-dimensionally fabricated objects with wax. For example, Patent Literature 1 discloses, as a photocurable material used for 3D printers, a photocurable material containing a soluble resin for use in the production of a sacrificial mold. However, sacrificial molds should provide casting molds with high accuracy without surface dissolution or swelling during the fabrication, and should be able to be melted and easily removed from investment materials without expansion or gasification at a relatively low temperature of 200° C. or lower. Cured products of conventional photocurable materials have not been able to meet these requirements.

### CITATION LIST

### Patent Literature

Patent Literature 1: JP 2020-526413 A

### SUMMARY OF INVENTION

### Technical Problem

The present invention aims to provide a resin composition for three-dimensional photofabrication which, after curing, melts at a relatively low temperature of about 200° C. and which is excellent in fabricability.

### Solution to Problem

The present inventors variously studied and then found that a resin composition for three-dimensional photofabrication containing a reactive material with a specified chemical structure, after curing, melts at a relatively low temperature of about 200° C. and is also excellent in fabricability. This finding has led to the completion of the present invention.

Specifically, the present invention relates to a resin composition for three-dimensional photofabrication, containing a reactive material having in a molecule thereof an acetal structure and a crosslinkable double bond.

The reactive material is preferably a reaction product of a compound having two or more crosslinkable double bonds and an alcohol compound having a crosslinkable double bond or a carboxylic acid compound having a crosslinkable double bond.

The reactive material preferably has a thermal decomposition temperature of 80° C. to 200° C. as measured by thermogravimetry-differential thermal analysis.

The resin composition for three-dimensional photofabrication preferably further contains a reactive monomer, a non-reactive compound having a melting point of 20° C. to 150° C., and a photopolymerization initiator.

The resin composition for three-dimensional photofabrication preferably further contains a polymerization inhibitor.

The resin composition for three-dimensional photofabrication preferably further contains a chain transfer agent.

A cured product of the resin composition preferably has a main tan δ peak temperature of 40° C. or higher.

The reactive monomer is preferably a reactive monomer whose homopolymer has a glass transition temperature of 40° C. or higher.

The present invention also relates to a three-dimensionally fabricated object, obtained by photocuring the resin composition for three-dimensional photofabrication.

The three-dimensionally fabricated object is preferably for use as a prototype for producing a casting mold.

The present invention also relates to a method for producing a cast product, the method including:
1) photocuring the resin composition for three-dimensional photofabrication to form a three-dimensionally fabricated object,
2) investing the three-dimensionally fabricated object in an investment material and solidifying the investment material,
3) removing the three-dimensionally fabricated object to form a casting mold of the investment material for providing a cast product, and
4) pouring a metal material into the casting mold and solidifying the metal material to provide a cast product.

### Advantageous Effects of Invention

The resin composition for three-dimensional photofabrication of the present invention, after curing, is able to melt at a relatively low temperature of about 200° C. and is also excellent in fabricability. A three-dimensionally fabricated object obtained by photocuring the resin composition for three-dimensional photofabrication is particularly suitable for use as a prototype for producing a casting mold for producing a small-lot forged product.

### BRIEF DESCRIPTION OF DRAWINGS

FIG. 1 includes schematic diagrams for illustrating the steps of forming a three-dimensionally fabricated object from a resin composition for three-dimensional photofabrication according to an embodiment of the present invention by photofabrication.

### DESCRIPTION OF EMBODIMENTS

### <<Resin Composition for Three-Dimensional Photofabrication>>

The resin composition for three-dimensional photofabrication of the present invention is characterized by containing a reactive material having an acetal structure and a crosslinkable double bond in the molecule.

### <Reactive Material Having in Molecule Thereof Acetal Structure and Crosslinkable Double Bond>

The reactive material may be any reactive material that has an acetal structure and a crosslinkable double bond in the molecule. The incorporation of the reactive material having an acetal structure and a crosslinkable double bond in the molecule enables the resin composition for three-dimensional photofabrication, after curing, to melt at a relatively low temperature of about 200° C. Moreover, due to the presence of a crosslinkable double bond, the cured product is unlikely to undergo surface dissolution or swelling and is excellent in fabricability. Further, the resin composition for three-dimensional photofabrication with the reactive material having an acetal structure and a crosslinkable double bond in the molecule can be dissolved in water or an aqueous solution containing water.

The acetal structure may be either an acetal structure formed from an aldehyde and an alcohol, or a ketal structure formed from a ketone and an alcohol. Examples of the crosslinkable double bond include a (meth)acrylic group, a vinyl group, and a (meth)acryloxy group.

The number of acetal structures in the molecule of the reactive material is one or more, preferably two or more. The number of crosslinkable double bonds in the molecule of the reactive material is one or more, preferably two or more. If the reactive material has two or more crosslinkable double bonds, these crosslinkable double bonds may be the same as or different from each other.

The reactive material is preferably a reaction product of a compound having two or more crosslinkable double bonds and an alcohol compound having a crosslinkable double bond or a carboxylic acid compound having a crosslinkable double bond. In the reaction product, an acetal structure is formed by binding of the crosslinkable double bond of the compound having two or more crosslinkable double bonds and the hydroxyl group of the alcohol compound having a crosslinkable double bond or the carboxy group of the carboxylic acid compound having a crosslinkable double bond. Specific examples of the binding for forming the acetal structure include binding of a vinyl group and a hydroxyl group, and binding of a (meth)acrylic group and a carboxyl group.

Examples of the compound having two or more crosslinkable double bonds include 2-(2-vinyloxyethoxy)ethyl acrylate (VEEA), di(ethylene glycol) divinyl ether (DEGDVE), 2-vinyloxyethyl methacrylate, cyclohexane dimethanol divinyl ether (CHDVE), butanediol divinyl ether (BDVE), triethylene glycol divinyl ether (TEGDVE), 1,4-cyclohexanediol divinyl ether (CHODVE), neopentyl glycol divinyl ether (NPGDVE), trimethylolpropane trivinyl ether (TMPTVE), and pentaerythritol tetravinyl ether (PETTVE), with 2-(2-vinyloxyethoxy)ethyl acrylate or di(ethylene glycol) divinyl ether being preferred.

Examples of the carboxylic acid compound having a crosslinkable double bond include 2-acryloyloxyethyl succinate (HOA-MS(N)), 2-acryloyloxyethyl cyclohexanedicarboxylate (HOA-HH(N)), and (meth)acrylic acid, with 2-acryloyloxyethyl succinate being preferred.

Examples of the alcohol compound having a crosslinkable double bond include 2-hydroxyethyl acrylate and 4-hydroxybutyl acrylate.

The reaction of the compound having two or more crosslinkable double bonds and the alcohol compound having a crosslinkable double bond can be performed by mixing 0.9 to 1.1 equivalents of the alcohol compound having a crosslinkable double bond relative to the compound having two or more crosslinkable double bonds, and heating them. The reaction allows for the synthesis of a reactive material having one acetal structure.

The reactive material having an acetal structure and a crosslinkable double bond in the molecule can also be synthesized by mixing 1.8 to 2.2 equivalents of the alcohol compound having a crosslinkable double bond relative to the compound having two or more crosslinkable double bonds, and heating them. The reactive material can also be synthesized by mixing 0.45 to 0.55 equivalents of a dicarboxylic acid relative to the compound having two or more crosslinkable double bonds, and heating them. The reaction allows for the synthesis of a reactive material having two or more acetal structures.

The reactive material having an acetal structure and a crosslinkable double bond in the molecule can also be synthesized by mixing 0.30 to 0.36 equivalents of a compound having three or more crosslinkable double bonds relative to the compound having a crosslinkable double bond and a carboxyl group, and heating them. The reaction allows for the synthesis of a reactive material having three or more acetal structures. Examples of the compound having three or more crosslinkable double bonds include trimethylolpropane trivinyl ether (TMPTVE).

The heating temperature is preferably 40° C. to 120° C., more preferably 60° C. to 100° C. The heating time is preferably 1 to 24 hours, more preferably 2 to 12 hours. A heating temperature of lower than 40° C. or a heating time of less than 1 hour may fail to provide the target reactive material. A heating temperature of higher than 120° C. or a heating time of more than 24 hours may cause a reduction in yield due to decomposition of the acetal bond in the reaction product, a side reaction of the crosslinkable double bond, etc.

Although a reaction solvent may be used in the reaction of the compound having two or more crosslinkable double bonds and the alcohol compound having a crosslinkable double bond, a predetermined reactive material can be obtained without using a reaction solvent. When the compound having two or more crosslinkable double bonds and the alcohol compound having a crosslinkable double bond are reacted without using a reaction solvent, the resulting reaction product can be directly used in a resin composition for a three-dimensional photofabrication material without undergoing an extraction step and/or a purification step.

The reactive material preferably has a thermal decomposition temperature of 80° C. to 200° C., more preferably 120° C. to 180° C., as measured by thermogravimetry-differential thermal analysis. A thermal decomposition temperature of lower than 80° C. may cause deterioration in the fabricability of the cured product of the resin composition for three-dimensional photofabrication, while a thermal decomposition temperature of higher than 200° C. may necessitate heating at a high temperature of higher than 200° C. during the removal of the cured product from a casting mold of an investment material.

Examples of the reactive material include compounds represented by the following formula:

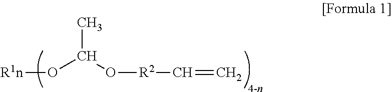

wherein R¹ and R² are each independently a C1-C20, preferably C2-C10 hydrocarbon group optionally containing an oxygen atom; and n is 1 or 2.

More specific examples include compounds of the following formulae.

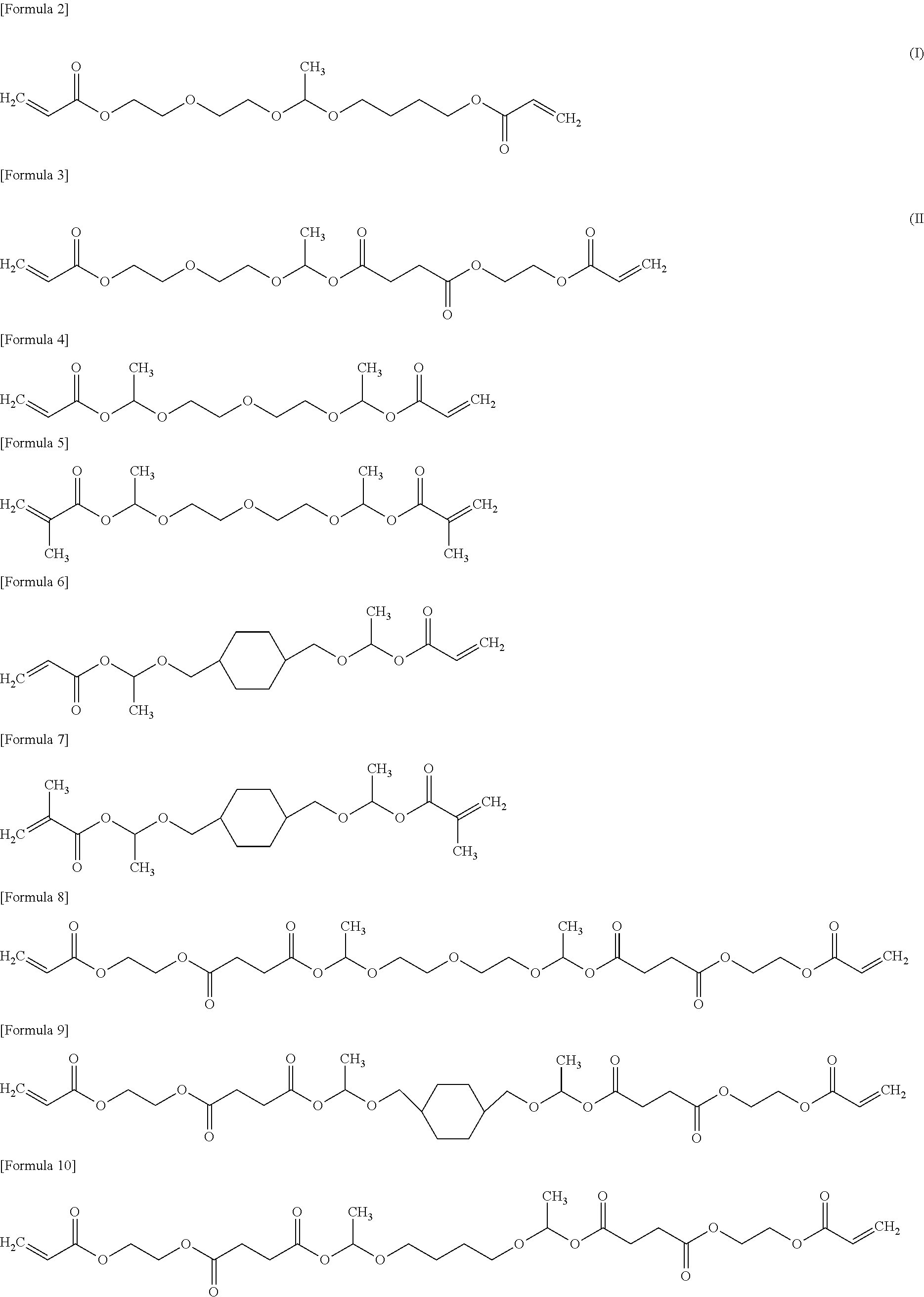

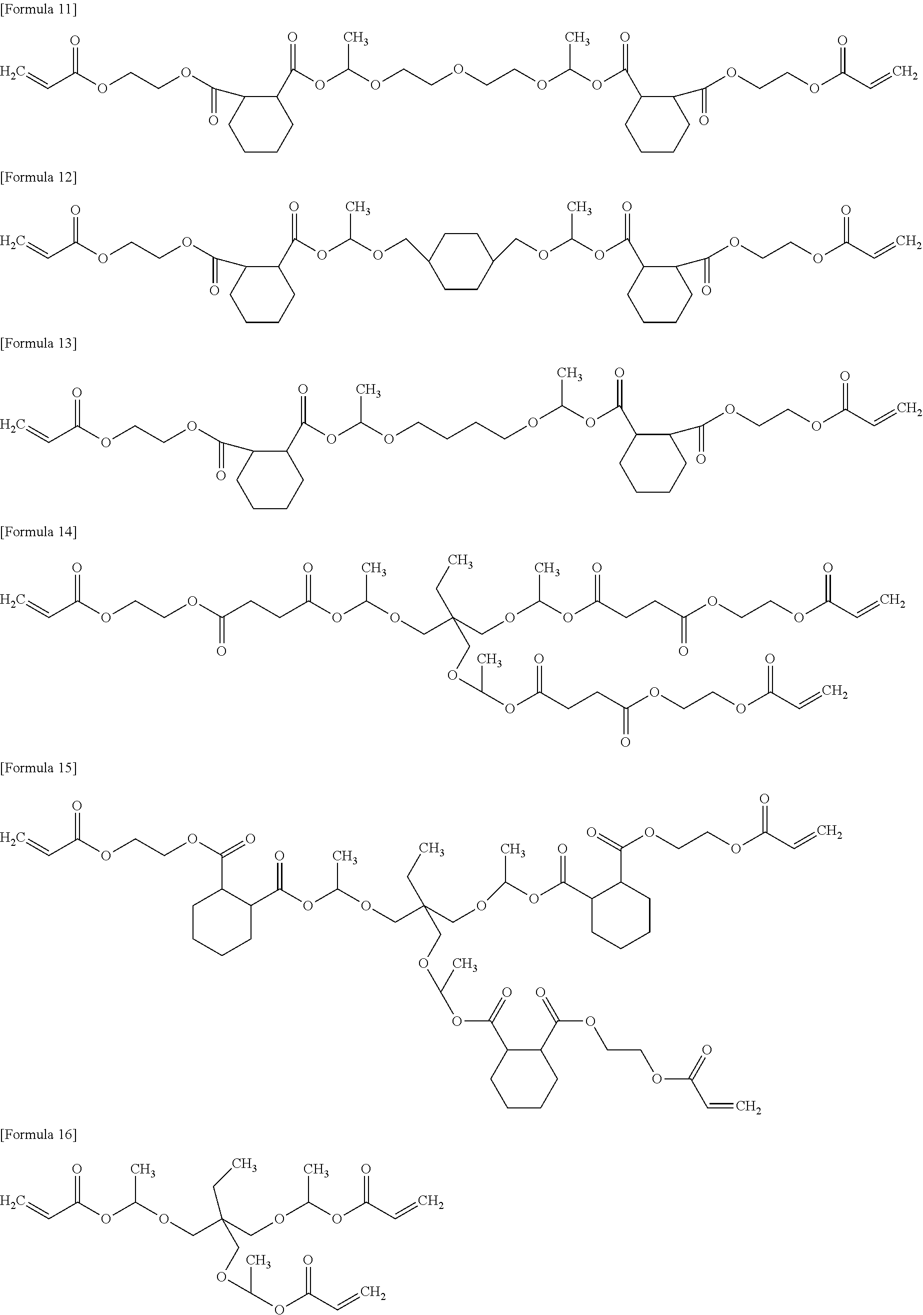

The amount of the reactive material in the resin composition for three-dimensional photofabrication of the present invention is preferably, but not limited to, 40 to 95% by mass, more preferably 60 to 90% by mass. An amount of more than 95% by mass tends to cause deterioration in the castability of the cured product, while an amount of less than 40% by mass tends to cause deterioration in the fabricability of the cured product.

When the resin composition for three-dimensional photofabrication contains a reactive monomer as described later in addition to the reactive material, the ratio of the reactive monomer to the reactive material by weight is preferably 99.9/0.1 to 80/20, more preferably 99.8/0.2 to 90/10. A reactive monomer ratio of more than 99.9 may make it difficult to melt by heating the three-dimensionally fabricated object formed from the cured product of the resin composition for three-dimensional photofabrication, while a reactive monomer ratio of less than 80 may result in insufficient photocuring and make it difficult to form a three-dimensionally fabricated object.

### <Reactive Monomer>

The resin composition for three-dimensional photofabrication preferably contains a reactive monomer in addition to the reactive material having an acetal structure and a crosslinkable double bond in the molecule. The reactive monomer is preferably a monomer whose homopolymer has a glass transition temperature of 40° C. or higher. The glass transition temperature is preferably 80° C. or higher, more preferably 100° C. or higher. A glass transition temperature of lower than 40° C. can result in poor heat resistance. Here, the glass transition temperature may be measured on a homopolymer actually polymerized or may be calculated by the group contribution method.

The reactive monomer may be a photocurable monomer that is curable or polymerizable by the action of radicals, ions, etc., generated by light irradiation. The photocurable monomer is preferably a monomer having a polymerizable functional group. The number of polymerizable functional groups in the photocurable monomer is one. Examples of the polymerizable functional group include groups having a polymerizable carbon-carbon unsaturated bond, such as a vinyl group and an allyl group, and an epoxy group.

Specific examples include radical polymerizable monomers such as (meth)acrylic monomers and cationic polymerizable monomers such as epoxy monomers, vinyl monomers, and diene monomers. Among these, (meth)acrylic monomers or vinyl monomers are preferred in terms of the reaction rate.

Examples of the (meth)acrylic monomers include monomers containing a (meth)acryloyl group. Examples include methacrylic acid esters such as methyl (meth)acrylate, ethyl (meth)acrylate, n-butyl (meth)acrylate, isobutyl (meth)acrylate, t-butyl (meth)acrylate, neopentyl (meth)acrylate, cyclohexyl (meth)acrylate, benzyl (meth)acrylate, octyl (meth)acrylate, lauryl (meth)acrylate, stearyl (meth)acrylate, cetyl (meth)acrylate, ethylcarbitol (meth)acrylate, hydroxyethyl (meth)acrylate, hydroxypropyl (meth)acrylate, hydroxybutyl (meth)acrylate, methoxyethyl (meth)acrylate, methoxybutyl (meth)acrylate, and isobornyl (meth)acrylate; (meth)acrylic acid amides such as N-methyl (meth)acrylamide, N-ethyl (meth)acrylamide, N-propyl (meth)acrylamide, N-isopropyl (meth)acrylamide, N-butoxymethyl (meth)acrylamide, N-t-butyl (meth)acrylamide, N-octyl (meth)acrylamide, N,N-dimethyl (meth)acrylamide, N,N-diethyl (meth)acrylamide, (meth)acryloyl morpholine, and diacetone (meth)acrylamide; and styrene, methyl itaconate, ethyl itaconate, vinyl acetate, vinyl propionate, N-vinyl pyrrolidone, N-vinylcaprolactam, and 3-vinyl-5-methyl-2-oxazolidinone. Among these, (meth)acrylic acid esters or (meth)acrylic acid amides are preferred from the standpoint of the Tg of the homopolymer. Moreover, isobornyl (meth)acrylate is preferred among the (meth)acrylic acid esters, while (meth)acryloyl morpholine, N,N-dimethyl (meth)acrylamide, N,N-diethyl (meth)acrylamide, and dimethylaminopropyl acrylamide are preferred among the (meth)acrylic acid amides.

A (meth)acrylic acid ester and a (meth)acrylic acid amide may be used in combination as (meth)acrylic monomers. The ratio of the (meth)acrylic acid ester to the (meth)acrylic acid amide, if used in combination, by weight is preferably 1/99 to 60/40, more preferably 5/95 to 50/50. A (meth)acrylic acid ester ratio of more than 60 may cause softening and make fabrication difficult, while a (meth)acrylic acid ester ratio of lower than 1 may make thermal dissolution difficult. Herein, “acrylic acid” and “methacrylic acid” may be collectively referred to as “(meth)acrylic acid”, and “acrylic acid ester (or acrylate)” and “methacrylic acid ester (or methacrylate)” may also be collectively referred to as “(meth)acrylic acid ester (or (meth)acrylate)”.

Examples of the vinyl monomers include vinyl ethers such as polyol poly(vinyl ethers), aromatic vinyl monomers such as styrene, and vinylalkoxysilanes. Examples of the polyols constituting the polyol poly(vinyl ethers) include polyols (butanediol) exemplified for the acrylic monomers. Examples of the diene monomers include isoprene and butadiene.

Examples of the epoxy monomers include compounds having one epoxy group in the molecule. Examples of the epoxy monomers include compounds having an epoxy cyclohexane ring or a 2,3-epoxypropyloxy group.

The amount of the reactive monomer in the resin composition for three-dimensional photofabrication of the present invention is preferably, but not limited to, 1 to 99.5% by mass, more preferably 50 to 90% by mass. An amount of less than 1% by mass tends to cause the resin to have a high viscosity, while an amount of more than 99.5% by mass tends to cause greater cure shrinkage.

### <Non-Reactive Compound>

The resin composition for three-dimensional photofabrication preferably contains a non-reactive compound having a melting point of 20° C. to 150° C. in addition to the reactive material having an acetal structure and a crosslinkable double bond in the molecule. The non-reactive compound may be any compound that does not react with the reactive monomer. Examples of non-reactive polymers include polyethers such as polyethylene glycol, polypropylene glycol, and polytetramethylene glycol, polycarbonates, acrylic resins, polyesters, and polyurethanes. Examples of non-reactive monomers include epoxy compounds, alicyclic epoxy compounds, and oxetane compounds. Examples of non-reactive compounds other than these include isocyanate compounds and phenol compounds.

The non-reactive compound may have any melting point that is 20° C. to 150° C., preferably 30° C. to 120° C., more preferably 40° C. to 100° C. If the melting point of the non-reactive compound is lower than 20° C., the three-dimensionally fabricated object formed from the cured product of the resin composition for three-dimensional photofabrication may melt at ordinary temperature and fail to be used as a prototype for casting production. If the melting point is higher than 150° C., it may be difficult to melt and remove the three-dimensionally fabricated object by heating.

The weight average molecular weight of the non-reactive polymer is preferably, but not limited to, 500 to 30000, more preferably 800 to 10000. A weight average molecular weight of less than 500 may easily cause bleed out after curing, while a weight average molecular weight of greater than 30000 may cause the three-dimensionally fabricated object formed from the cured product of the resin composition for three-dimensional photofabrication to have a higher viscosity after melting, thus making it difficult to remove it.

The ratio of the reactive monomer to the non-reactive compound by weight is preferably 90/10 to 30/70, more preferably 80/20 to 50/50. A reactive monomer ratio of greater than 90 may make it difficult to melt by heating the three-dimensionally fabricated object formed from the cured product of the resin composition for three-dimensional photofabrication, while a reactive monomer ratio of less than 30 may result in insufficient photocuring and make it difficult to form a three-dimensionally fabricated object.

The amount of the non-reactive compound is preferably, but not limited to, 10 to 70% by mass, more preferably 20 to 50% by mass. An amount of less than 10% by mass may make it difficult to melt by heating the three-dimensionally fabricated object formed from the cured product of the resin composition for three-dimensional photofabrication, while an amount of more than 70% by mass may cause the resin composition for three-dimensional photofabrication to solidify so that it cannot maintain the liquid form.

### <Photopolymerization Initiator>

The resin composition for three-dimensional photofabrication preferably contains a photopolymerization initiator in addition to the reactive material having an acetal structure and a crosslinkable double bond in the molecule. The photopolymerization initiator can be activated by the action of light to initiate the polymerization of the reactive monomer. Examples of the photopolymerization initiator include radical polymerization initiators that generate radicals by the action of light as well as those which generate bases (or anions) or acids (or cations) by the action of light (specifically, anion generators and cation generators). The photopolymerization initiator can be selected according to the type of the photocurable monomer, e.g., whether the photocurable monomer is radically polymerizable or ionically polymerizable. Examples of the radical polymerization initiators (radical photopolymerization initiators) include alkylphenone photopolymerization initiators and acylphosphine oxide photopolymerization initiators.

Examples of the alkylphenone photopolymerization initiators include 2,2-dimethoxy-1,2-diphenylethan-1-one, 1-hydroxy-cyclohexyl-phenyl-ketone, 2-hydroxy-2-methyl-1-phenyl-propan-1-one, 1-[4-(2-hydroxyethoxy)-phenyl]-2-hydroxy-2-methyl-1-propan-1-one, 2-hydroxy-1-{4-[4-(2-hydroxy-2-methyl-propionyl)-benzyl]phenyl}-2-methyl-propan-1-one, 2-methyl-1-(4-methylthiophenyl)-2-morpholinopropan-1-one, 2-benzyl-2-dimethylamino-1-(4-morpholinophenyl)-butanone-1, and 2-(dimethylamino)-2-[(4-methylphenyl)methyl]-1-[4-(4-morpholinyl)phenyl]-1-butanone.

Examples of the acylphosphine oxide photopolymerization initiators include 2,4,6-trimethylbenzoyl-diphenyl-phosphine oxide and bis(2,4,6-trimethylbenzoyl)-phenylphosphine oxide.

The amount of the photopolymerization initiator added is preferably 0.01 to 10 parts by weight, more preferably 0.1 to 5 parts by weight relative to 100 parts by weight of the reactive monomer. An amount of less than 0.01 parts by weight tends to result in poor curing, while an amount of more than 10 parts by weight tends to cause poor storage stability and absorption, thereby resulting in poor curing.

### <Additive>

The resin composition for three-dimensional photofabrication of the present invention can contain known additives such as a polymerization inhibitor, a chain transfer agent, wax particles, a curable resin, a dye, an ultraviolet sensitizer, a plasticizer, an ultraviolet absorber, a pigment, and a surfactant.

Examples of the polymerization inhibitor include 4-methoxyphenol, hydroquinone, methylhydroquinone, tert-butyl-hydroquinone, hydroquinone monomethyl ether, 4-methylquinoline, phenothiazine, 2,6-diisobutylphenol, 2,6-di-tert-butyl-4-methylphenol, ammonium-N-nitrosophenylhydroxylamine, and N-nitrosophenylhydroxylamine ammonium. The amount of the polymerization inhibitor is preferably 0.001 to 1.0% by mass, more preferably 0.01 to 0.3% by mass based on the total composition.

The chain transfer agent may be incorporated to control the degree of polymerization of the reactive monomer (the molecular weight of the polymer formed from the reactive monomer). Examples of the chain transfer agent include thiol group-containing compounds such as 3-mercaptopropylmethyldimethoxysilane, 1,4-bis(3-mercaptobutyryloxy)butane, and pentaerythritol tetrakis(3-mercaptobutylate). The amount of the chain transfer agent is preferably 0.00001 to 5% by mass, more preferably 0.0001 to 1% by mass based on the total composition.

### <Physical Properties of Resin Composition for Three-Dimensional Photofabrication and Cured Product>

The resin composition for three-dimensional photofabrication of the present invention is preferably in the liquid form at room temperature. The resin composition in the liquid form at room temperature can be easily subjected to photofabrication using a 3D printer, for example. The resin composition for three-dimensional photofabrication of the present invention preferably has a viscosity at 25° C. of 5000 mPa⋅s or lower, more preferably 2000 mPa⋅s or lower. Here, the viscosity of the resin composition can be measured using an E-type (cone and plate) viscometer at a rotational speed of 20 rpm.

The main tan δ peak temperature of the cured product of the resin composition for three-dimensional photofabrication of the present invention is preferably, but not limited to, 40° C. or higher, more preferably 50° C. or higher, still more preferably 60° C. or higher, further preferably 80° C. or higher. A main tan δ peak temperature of lower than 40° C. can lead to insufficient heat resistance. The tan δ refers to the Tg value measured using a dynamic viscoelastic analyzer (DMA). It can be measured while the temperature of the cured product is increased from a low temperature to a high temperature (e.g., from −100° C. to +200° C.). If there are multiple peaks, the temperature of the higher peak (main peak) is used.

The Shore D hardness of the cured product of the resin composition for three-dimensional photofabrication of the present invention is preferably, but not limited to, 30 or higher, more preferably 45 or higher, still more preferably 60 or higher. A Shore D hardness of lower than 30 tends to lead to insufficient strength. Here, the Shore D hardness is measured in conformity with JIS K7215:1986 using a type D durometer.

### <<Three-Dimensionally Fabricated Object>>

The resin composition for three-dimensional photofabrication of the present invention can be formed into 2D, 3D, or other fabricated objects (or patterns) by a variety of fabricating methods and is particularly suitable for photofabrication. The resin composition for three-dimensional photofabrication can be in the liquid form at room temperature and may therefore be used for vat-type photofabrication or inkjet-type photofabrication, for example.

The three-dimensionally fabricated object of the present invention, which is a fabricated object (cured product) obtained by photocuring the resin composition for three-dimensional photofabrication of the present invention, can be easily removed from a casting mold of an investment material, e.g., by melting by heating to about 150° C. Therefore, the three-dimensionally fabricated object is suitable for use as a prototype for producing a casting mold. In particular, it is optimal as a prototype of a casting mold for a small-lot forged product. Further, the three-dimensionally fabricated object of the present invention, which contains a reactive material having an acetal structure and a crosslinkable double bond in the molecule, can also be dissolved in water or an aqueous solution containing water and then removed. By utilizing these features, the three-dimensionally fabricated object of the present invention can also be used as a sacrificial mold.

### <<Method for Producing Cast Product>>

The method for producing a cast product of the present invention includes:
1) photocuring the resin composition for three-dimensional photofabrication of the present invention to form a three-dimensionally fabricated object,
2) investing the three-dimensionally fabricated object in an investment material and solidifying the investment material,
3) removing the three-dimensionally fabricated object to form a casting mold of the investment material for providing a cast product, and
4) pouring a metal material into the casting mold and solidifying the metal material to provide a cast product.

1) The step 1) of photocuring the resin composition for three-dimensional photofabrication of the present invention to form a three-dimensionally fabricated object includes:
1-1) forming a first liquid film from the resin composition for three-dimensional photofabrication of the present invention and curing the first liquid film to form a first pattern; and
1-2) forming a second liquid film from the resin composition for three-dimensional photofabrication of the present invention so that it is in contact with the first pattern, and curing the second liquid film to stack a second pattern, thereby forming a three-dimensionally fabricated object.

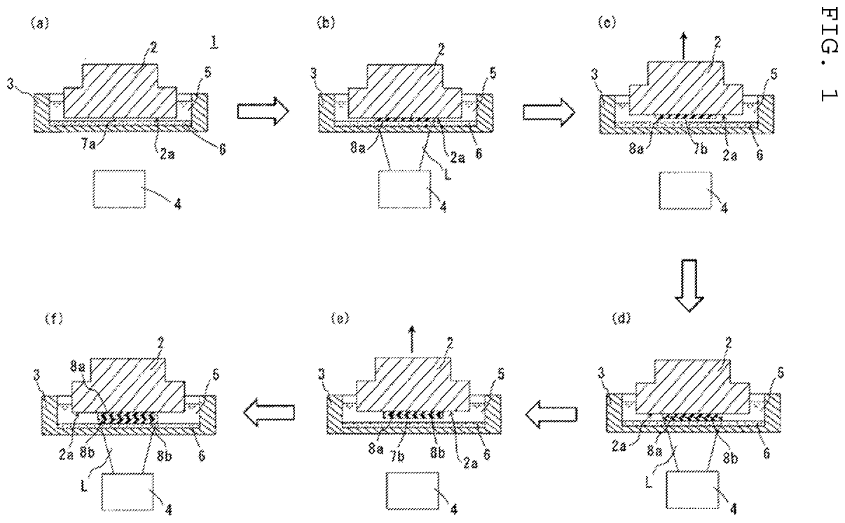

With reference to FIG. 1, the following describes the procedures of vat-type photofabrication. FIG. 1 illustrates an example of forming a three-dimensionally fabricated object using a photofabrication device (patterning device) including a resin tank (vat). The illustrated example shows a bottom-up fabrication, but any method is applicable in which three-dimensional photofabrication can be achieved with the resin composition for three-dimensional photofabrication. Also, any mode of light irradiation (light exposure) can be used and may be either point exposure or surface exposure.

A photofabrication device 1 includes a platform 2 including a pattern-forming surface 2a, a resin tank 3 containing a resin composition for three-dimensional photofabrication 5, and a projector 4 as a surface-exposure light source.

### 1-1) Step of Forming and Curing First Liquid Film to Form First Pattern

In the step 1-1), as shown in (a), the pattern-forming surface 2a of the platform 2 facing the projector 4 (the bottom of the resin tank 3) may be first immersed in the resin composition for three-dimensional photofabrication 5 contained in the resin tank 3. At this time, the level of the pattern-forming surface 2a (or the platform 2) may be adjusted so that a liquid film 7a (liquid film a) is formed between the pattern-forming surface 2a and the projector 4 (or the bottom of the resin tank 3). Then, as shown in (b), light L irradiation (surface exposure) from the projector 4 towards the liquid film 7a may be performed to photocure the liquid film 7a, thereby forming a first pattern 8a (pattern a).

In the photofabrication device 1, the resin tank 3 serves as a unit for supplying the resin composition for three-dimensional photofabrication 5. In order to irradiate light from the light source to the liquid film, at least a portion of the resin tank between the liquid film and the projector 4 (the bottom in FIG. 1) is desirably transparent to the exposure wavelength. The shape, material, size, etc. of the platform 2 are not limited.

After the liquid film a is formed, light may be irradiated from the light source towards the liquid film a to photocure the liquid film a. The light irradiation can be performed by a known method. Any mode of light irradiation can be used and may be either point exposure or surface exposure. The light source used may be a known light source used for photocuring. In the point exposure mode, examples include plotter systems, galvo laser (or galvo scanner) systems, and stereolithography (SLA) systems. In the surface exposure mode, the light source is preferably a projector in terms of simplicity. Examples of the projector include transmissive liquid crystal (LCD) systems, reflective liquid crystal (LCoS) systems, and digital light processing (DLP®) systems. The exposure wavelength can be selected as appropriate according to the components (particularly, the type of the photopolymerization initiator) of the resin composition for three-dimensional photofabrication.

1-2) Step of Forming Second Liquid Film so that it is in Contact with First Pattern, and Curing Second Liquid Film to Stack Second Pattern, Thereby Producing Three-Dimensionally Fabricated Object

In the step 1-2), the resin composition for three-dimensional photofabrication 5 may be supplied between the pattern a obtained in the step 1-1) and the light source to form a liquid film (liquid film b). In other words, the liquid film b may be formed on the pattern a provided on the pattern-forming surface. The resin composition for three-dimensional photofabrication 5 may be supplied in the same manner as in the step 1-1).

For example, as shown in FIG. 1 (c), after the first pattern 8a (2D pattern a) is formed, the first pattern-forming surface 2a may be raised with the platform 2. Then, the resin composition for three-dimensional photofabrication 5 may be supplied between the first pattern 8a and the bottom of the resin tank 3 to form a liquid film 7b (liquid film b).

The formed liquid film b may be exposed to light from the light source to photocure the liquid film b, thereby stacking another pattern (a pattern b obtained by photocuring the liquid film b) on the first pattern a. Such pattern stacking in the thickness direction enables the formation of a three-dimensionally fabricated pattern.

For example, as shown in FIG. 1 (d), the liquid film 7b (liquid film b) provided between the first pattern 8a (pattern a) and the bottom of the resin tank 3 may be exposed to light from the projector 4 to photocure the liquid film 7b. This photocuring can convert the liquid film 7b into a second pattern 8b (pattern b). In this manner, the second pattern 8b can be stacked on the first pattern 8a. With respect to the light source, exposure wavelength, etc., reference may be made to the description of the step 1-1).

The step 1-2) can be repeated multiple times. Repetition allows for stacking of a plurality of patterns b in the thickness direction, resulting in a more stereoscopically fabricated pattern. The number of repetitions can be determined as appropriate according to the shape, size, etc. of the desired three-dimensionally fabricated object (three-dimensionally fabricated pattern).

For example, as shown in FIG. 1 (e), the platform 2 may be raised with the first pattern 8a (pattern a) and the second pattern 8b (pattern b) being stacked on the pattern-forming surface 2a. At this time, a liquid film 7b (liquid film b) can be formed between the second pattern 8b and the bottom of the resin tank 3. Then, as shown in FIG. 1 (f), the liquid film 7b may be exposed to light from the projector 4 to photocure the liquid film 7b. Thus, another pattern 8b (pattern b) can be formed on the first pattern 8b. Then, by alternately repeating the steps (e) and (f), a plurality of patterns 8b (2D patterns b) can be stacked.

The step 1) preferably further includes washing the first pattern and the second pattern with a solvent. Since the resulting three-dimensionally fabricated pattern has the uncured resin composition for three-dimensional photofabrication attached thereto, the washing can be performed to remove such a composition. The solvent is preferably one having a Hansen solubility parameter of 25 MPa^{0.5} or lower. Specific examples of the solvent include 3-methoxy-3-methyl-1-butanol.

The resulting three-dimensionally fabricated pattern may be subjected to post-curing, if necessary. The post-curing may be performed by exposing the pattern to light. The light irradiation conditions may be adjusted as appropriate according to the type of the resin composition for three-dimensional photofabrication, the degree of curing of the resulting pattern, etc. The post-curing may be performed on a part of the pattern or the entire pattern.

### 2) Step of Investing Three-Dimensionally Fabricated Object in Investment Material and Solidifying Investment Material

Examples of the investment material include, but not limited to, gypsum investment materials such as cristobalite investment materials and quartz investment materials, and phosphate investment materials. The three-dimensionally fabricated object is preferably invested in the investment material at ordinary temperature. The investment material may be solidified at ordinary temperature, or may be solidified while warming in order to promote water removal. The temperature during the warming is preferably 120° C. or lower. The other conditions adopted can be conventionally known conditions.

### 3) Step of Removing Three-Dimensionally Fabricated Object to Form Casting Mold of Investment Material for Providing Cast Product

When the three-dimensionally fabricated object is removed by heating, the heating temperature is preferably, but not limited to, 100° C. to 1000° C., more preferably 150° C. to 800° C. A heating temperature of lower than 100° C. may not allow the three-dimensionally fabricated object to melt sufficiently, making it difficult to remove the three-dimensionally fabricated object from the casting mold of the investment material, while a heating temperature of 1000° C. or higher may render the investment material unable to stand. The three-dimensionally fabricated object can also be removed by dissolving it in water or an aqueous solution containing water.

4) Step of Pouring Metal Material into Casting Mold and Solidifying Metal Material to Provide Cast Product

Examples of the metal material include, but not limited to, titanium, cobalt, nickel, chromium, gold, silver, platinum, and alloys thereof. The method for pouring the metal material into the casting mold, and the method for solidifying the metal material adopted can be conventionally known methods.

The cast product obtained by the method for producing a cast product of the present invention is suitable for use in applications in dentistry, jewelry, and other fields.

### EXAMPLES

The present invention is described below with reference to examples although the present invention is not limited to the following examples. Hereinafter, the terms “part(s)” and “%” represent “part(s) by weight” and “% by weight”, respectively, unless otherwise specified.

The chemicals used in the examples and comparative examples are listed below.

### <<Reactive Material>>

Polytetramethylene glycol #650 diacrylate (A-PTMG65, thermal decomposition temperature 258° C., available from Shin-Nakamura Chemical Co., Ltd.)
2-(2-Vinyloxyethoxy)ethyl acrylate (VEEA, thermal decomposition temperature 348° C., available from Nippon Shokubai Co., Ltd.)
Cyclohexane divinyl ether (CHDVE, thermal decomposition temperature 350° C., available from Nippon Carbide Industries Co., Inc.)
Acetal compound 1 (Synthesis Example 1, thermal decomposition temperature 169° C.)
Acetal compound 2 (Synthesis Example 2, thermal decomposition temperature 160° C.)
Acetal compound 3 (Synthesis Example 3, thermal decomposition temperature 140° C.)
Acetal compound 4 (Synthesis Example 4, thermal decomposition temperature 140° C.)
Acetal compound 5 (Synthesis Example 5, thermal decomposition temperature 140° C.)

### <<Reactive Monomer>>

Isobornyl acrylate (IBXA) (Tg of homopolymer 97° C., available from Osaka Organic Chemical Industry Ltd.)

### <<Non-Reactive Compound>>

Epoxy compound (YL6810, melting point 45° C., available from Mitsubishi Chemical Corporation)

### <<Photopolymerization Initiator>>

Bis(2,4,6-trimethylbenzoyl)-phenylphosphine oxide (Omnirad 819 available from IGM resins)

### <<Chain Transfer Agent>>

Pentaerythritol tetrakis(3-mercaptobutyrate) (Karenz PE1 available from Showa Denko K.K.)

### <<Investment Material>>

Cristobalite investment material (Youdent Cristobalite F30 available from Youdent Corporation)

### <<Metal Material>>

Ag 925 (available from Ijima Kingin Kogyo Co., Ltd.)

### Synthesis Example 1

An amount of 7.74 g of 4-hydroxybutyl acrylate was mixed with 0.2 g of PM-21 (phosphate-containing acrylate: available from Nippon Kayaku Co., Ltd.) as a catalyst, and the mixture was stirred, followed by adding 10 g of VEEA (2-(2-vinyloxyethoxy)ethyl acrylate), increasing the temperature to 80° C., and then stirring the mixture for 6 hours to obtain an acetal compound 1 of the following formula (I) having one acetal bond.

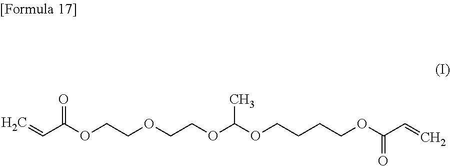 [SMILES: C=CC(=O)OCCCCOC(C)OCCOCCOC(=O)C=C]

### Synthesis Example 2

An amount of 5 g of VEEA (2-(2-vinyloxyethoxy)ethyl acrylate) was added to 5.805 g of 2-acryloyloxyethyl succinate, followed by increasing the temperature to 80° C. and then stirring the mixture for 6 hours to obtain an acetal compound 2 of the following formula (II) having one acetal bond.

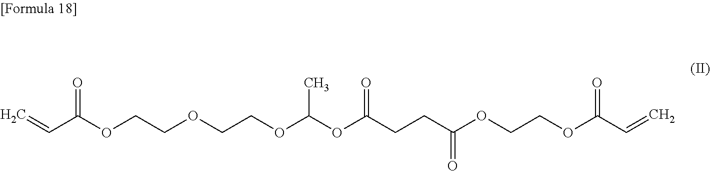 [SMILES: C=CC(=O)OCCOCCOC(C)OC(=O)CCC(=O)OCCOC(=O)C=C]

### Synthesis Example 3

An amount of 0.07 g of 4-methoxyphenol as a polymerization inhibitor was dissolved in 5 g of cyclohexane dimethanol divinyl ether (CHDVE), followed by adding 11.014 g of 2-acryloyloxyethyl succinate, increasing the temperature to 80° C., and then stirring the mixture for 12 hours to obtain an acetal compound 3 of the following formula having two acetal bonds.

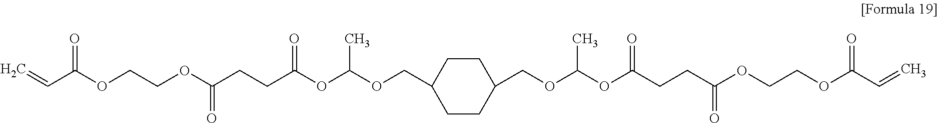 [SMILES: C=CC(=O)OCCOC(=O)CCC(=O)OC(C)OCC1CCC(COC(C)OC(=O)CCC(=O)OCCOC(=O)C=C)CC1]

### Synthesis Example 4

An amount of 0.14 g of 4-methoxyphenol as a polymerization inhibitor was dissolved in 10 g of cyclohexane dimethanol divinyl ether (CHDVE), followed by adding 6.865 g of acrylic acid, increasing the temperature to 80° C., and then stirring the mixture for 12 hours to obtain an acetal compound 4 of the following formula having two acetal bonds.

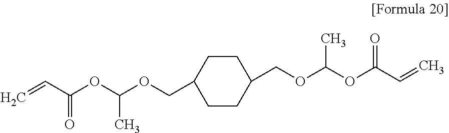 [SMILES: C=CC(=O)OC(C)OCC1CCC(COC(C)OC(=O)C=C)CC1]

### Synthesis Example 5

An amount of 0.05 g of 4-methoxyphenol as a polymerization inhibitor was dissolved in 3 g of trimethylolpropane trivinyl ether (TMPTVE), followed by adding 9.165 g of 2-acryloyloxyethyl succinate, increasing the temperature to 80° C., and then stirring the mixture for 12 hours to obtain an acetal compound 5 of the following formula having three acetal bonds.

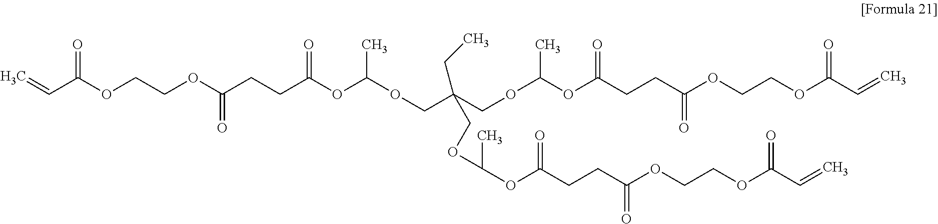 [SMILES: C=CC(=O)OCCOC(=O)CCC(=O)OC(C)OCC(CC)(COC(C)OC(=O)CCC(=O)OCCOC(=O)C=C)COC(C)OC(=O)CCC(=O)OCCOC(=O)C=C]

### Examples 1 to 7 and Comparative Examples 1 to 3

The components were mixed with each other in the amounts (weight ratio) shown in Table 1. The mixture was heated in an 80° C. oven with stirring to dissolve the solid components. Thus, a uniform liquid resin composition was prepared. The resin composition was subjected to the following evaluations. The evaluation results are shown in Table 1.

### <Hot Meltability>

Using an LCD-type 3D printer (Phrozen sonic mini, available from Phrozen Technology), a strip-shaped sample (length 35 mm×width 20 mm×thickness (height) 6 mm) was prepared under conditions including an irradiation time per layer of 15 seconds and a z-axis (height direction) pitch of 50 μm. This fabricated object was placed in an oven heated to 150° C., 200° C., or 250° C. for one hour and then visually observed for changes to evaluate the hot meltability using the following criteria.
Excellent: changed into low-viscosity liquid
Good: changed into liquid
Fair: changed in shape
Poor: no changes

### <Fabricability>

Using an LCD-type 3D printer (Phrozen sonic mini available from Phrozen Technology), a box-shaped sample (length 20 mm×width 20 mm×thickness (height) 20 mm) was prepared under conditions including an irradiation time per layer of 12 seconds and a z-axis (height direction) pitch of 50 μm. The resulting fabricated object was observed, and the fabricability was evaluated from the accuracy of the corner of the fabricated object using the following criteria.
Good: fabricated object having angulated corner
Poor: fabricated object having rounded corner

### <Castability>

Using an LCD-type 3D printer (Phrozen sonic mini available from Phrozen Technology), a strip-shaped sample (length 35 mm×width 20 mm×thickness (height) 6 mm) was prepared under conditions including an irradiation time per layer of 15 seconds and a z-axis (height direction) pitch of 50 μm. A cast product was produced with the resulting fabricated object, the investment material, and the metal material according to the method for producing a cast product described above, and the castability was evaluated using the following criteria.
Good: no burr formed in cast product
Poor: burr formed in cast product

TABLE 1

| | | | Compar- | Compar- | Compar- | | |
|---|---|---|---|---|---|---|---|
| | | | ative | ative | ative | Exam- | Exam- |
| | | | Example 1 | Example 2 | Example 3 | ple 1 | ple 2 |
| Resin | Reactive monomer | IBXA | 70 | 70 | 70 | 70 | 70 |
| composition | Non-reactive compound | YL6810 | 30 | 30 | 30 | 30 | 30 |
| for three- | Reactive material | A-PTMG65 | 0.2 | | | | |
| dimensional | | VEEA | | 0.2 | | | |
| photo- | | CHDVE | | | 0.2 | | |
| fabrication | | Acetal compound 1 (Synthesis Example 1) | | | | 0.2 | |
| | | Acetal compound 2 (Synthesis Example 2) | | | | | 0.2 |
| | | Acetal compound 4 (Synthesis Example 3) | | | | | |
| | | Acetal compound 4 (Synthesis Example 4) | | | | | |
| | | Acetal compound 5 (Synthesis Example 5) | | | | | |
| | Chain transfer agent | Karenz PE1 | 0.05 | 0.05 | 0.1 | 0.1 | 0 |
| | Photopolymerization | Omnirad 819 | 2 | 2 | 2 | 2 | 2 |
| | initiator | | | | | | |
| Cured | Hot meltability | 150° C. | Poor | Poor | Poor | Fair | Fair |
| product | | 200° C. | Poor | Poor | Poor | Excel- | Excel- |
| | | | | | | lent | lent |
| | | 250° C. | Poor | Poor | Poor | Excel- | Excel- |
| | | | | | | lent | lent |

| | | | | | |
|---|---|---|---|---|---|
| Fabricability | Good | Good | Fair | Good | Good |
| Castability | Poor | Poor | Poor | Good | Good |

| | | | Exam- | Exam- | Exam- | Exam- | Exam- |
|---|---|---|---|---|---|---|---|
| | | | ple 3 | ple 4 | ple 5 | ple 6 | ple 7 |
| Resin | Reactive monomer | IBXA | 70 | 70 | 70 | 70 | 70 |
| composition | Non-reactive compound | YL6810 | 30 | 30 | 30 | 30 | 30 |
| for three- | Reactive material | A-PTMG65 | | | | | |
| dimensional | | VEEA | | | | | |
| photo- | | CHDVE | | | | | |
| fabrication | | Acetal compound 1 (Synthesis Example 1) | | | | | |
| | | Acetal compound 2 (Synthesis Example 2) | 0.4 | | | | |
| | | Acetal compound 4 (Synthesis Example 3) | | 0.4 | 1 | | |
| | | Acetal compound 4 (Synthesis Example 4) | | | | 0.4 | |
| | | Acetal compound 5 (Synthesis Example 5) | | | | | 0.4 |
| | Chain transfer agent | Karenz PE1 | 0.1 | 0.1 | 0.1 | 0.1 | 0.1 |
| | Photopolymerization | Omnirad 819 | 2 | 2 | 2 | 2 | 2 |
| | initiator | | | | | | |
| Cured | Hot meltability | 150° C. | Good | Excel- | Excel- | Excel- | Excel- |
| product | | | | lent | lent | lent | lent |
| | | 200° C. | Excel- | Excel- | Excel- | Excel- | Excel- |
| | | | lent | lent | lent | lent | lent |
| | | 250° C. | Excel- | Excel- | Excel- | Excel- | Excel- |
| | | | lent | lent | lent | lent | lent |

| | | | | | |
|---|---|---|---|---|---|
| Fabricability | Good | Good | Excel- | Excel- | Excel- |
| | | | lent | lent | lent |
| Castability | Good | Good | Good | Good | Good |

The fabricated objects of Comparative Examples 1 to 3 failed to melt at 250° C. or lower. On the contrary, the fabricated objects of Examples 1 to 7 were able to melt at 250° C. or lower, and also had excellent fabricability and castability. In particular, the fabricated objects of Examples 5 to 7, which were prepared with a reactive material having two or more acetal bonds, were particularly excellent.

### REFERENCE SIGNS LIST

1: photofabrication device
2: platform
2a: pattern-forming surface
3: resin tank
4: projector
5: resin composition for three-dimensional fabrication
6: release agent layer
7a: liquid film a
7b: liquid film b
8a: first pattern a
8b: second pattern b
L: light

1. A resin composition for three-dimensional photofabrication, comprising
a reactive material having in a molecule thereof an acetal structure and a crosslinkable double bond,
wherein the reactive material is a reaction product of a compound having two or more crosslinkable double bonds with an alcohol compound having a crosslinkable double bond, or with a carboxylic acid compound having a crosslinkable double bond.

2. (canceled)

3. The resin composition for three-dimensional photofabrication according to claim 1,
wherein the reactive material has a thermal decomposition temperature of 80° C. to 200° C. as measured by thermogravimetry-differential thermal analysis.

4. The resin composition for three-dimensional photofabrication according to claim 1, further comprising:
a reactive monomer;
a non-reactive compound having a melting point of 20° C. to 150° C.; and
a photopolymerization initiator.

5. The resin composition for three-dimensional photofabrication according to claim 1, further comprising
a polymerization inhibitor.

6. The resin composition for three-dimensional photofabrication according to claim 1, further comprising
a chain transfer agent.

7. The resin composition for three-dimensional photofabrication according to claim 1,
wherein a cured product of the resin composition has a main tan δ peak temperature of 40° C. or higher.

8. The resin composition for three-dimensional photofabrication according to claim 4,
wherein the reactive monomer is a reactive monomer whose homopolymer has a glass transition temperature of 40° C. or higher.

9. A three-dimensionally fabricated object, obtained by photocuring the resin composition for three-dimensional photofabrication according to claim 1.

10. The three-dimensionally fabricated object according to claim 9 for use as a prototype for producing a casting mold.

11. A method for producing a cast product, the method comprising:
1) photocuring the resin composition for three-dimensional photofabrication according to claim 1 to form a three-dimensionally fabricated object,
2) investing the three-dimensionally fabricated object in an investment material and solidifying the investment material,
3) removing the three-dimensionally fabricated object to form a casting mold of the investment material for providing a cast product, and
4) pouring a metal material into the casting mold and solidifying the metal material to provide a cast product.
